(19) United States
(12) Patent Application Publication
(10) Pub. No.: US 2009/0063174 A1
(43) Pub. Date: Mar. 5, 2009

(54) Optimized Wireless Network Coverage

(75) Inventor: Volker FRICKE, Altdorf (DE)

Correspondence Address: IBM ST-SVL;SAWYER LAW GROUP LLP, 2465 E. Bayshore Road, Suite No. 406, PALO ALTO, CA, 94303, US

(73) Assignee: International Business Machines Corporation, Armonk, NY (US)

(21) Appl. No.: 11/848,010

(22) Filed: Aug. 30, 2007

(51) Int. Cl. G06Q 40/00; G01S 5/00

(52) U.S. Cl. 705/1

(57) ABSTRACT

A system and method for optimizing wireless network coverage. A system and method in accordance with the present invention for optimizing a wireless network are disclosed. In one embodiment, the system includes a telematics device that collects location, time, and speed information from a Global Positioning System module. The location, time, and speed information is used as insurance journey data. The telematics device also collects network quality data from a wireless network module (e.g. Global System for Mobile Communications). The telematics device sends the insurance journey data and network quality data to a telematics server to be forwarded to an insurance company server and a network operator server.

### FIELD OF THE INVENTION

The present invention relates to wireless networks, and more particularly to a system and method for optimizing network coverage.

### BACKGROUND OF THE INVENTION

There are currently many areas in countries where wireless networks (e.g., wide-area-networks (WANs)) or cellular networks (e.g. global system for mobile communications (GSM) networks, universal mobile telecommunications system (UMTS) networks, etc.) are not fully covered by wireless network operators. This means that in these areas the wireless network coverage is limited by poor or no reception of a wireless signal and therefore there is no possibility to make a voice or data call using a mobile phone. This is even more critical on roads when there is an emergency situation such as an accident and the driver needs call for help, or when an emergency-notification system installed in a vehicle triggered by an accident (e.g. air bag) is generating the call automatically. When there is no wireless network there, then the emergency call can't be made and help can not be provided in time.

The wireless network operators can theoretically calculate the wireless network coverage when they install new base stations. Wireless network operators can also monitor the quality of their networks manually by taking measurements of signal quality using measuring equipment or by studying the operation performance of their networks during normal calls, connection set up, paging, etc. However, these procedures are typically performed only when there are customer complaints or problems reported by users evaluating the problem at the specific area reported. A problem with this is that it often takes a long time until a network coverage problem is reported, and the location of the reported problem area is usually not very precise. Typically, only the city and general area is known. There are private web sites available were users can report problems about wireless network coverage. However, these complaints become public, which is not desirable for wireless network operators.

Accordingly, what is needed is an improved system and method for optimizing wireless networks. The present invention addresses such a need.

### SUMMARY OF THE INVENTION

A system and method for optimizing network coverage is disclosed. In one embodiment, the system includes a telecommunications and informatics (telematics) device or an application on a portable computer system such as a personal data assistant (PDA) or a Smart-Phone installed in a vehicle; a global positioning system (GPS) module or other means for collecting position and journey data relevant for example for insurance companies that includes location, time, and speed information of a vehicle; and a wireless network module for collecting network quality data. The wireless network module provides the wireless signal quality when the vehicle is in motion, and is also used as a standard phone to provide emergency voice calls in case of an accident. The system also includes a memory, where the telematics device receives the position data (location, time and speed) from the GPS module and stores the position and journey data in the memory. The telematics device receives the network quality data from the wireless network module and stores the network quality data in the memory. The telematics device compares the signal level from the wireless network module against a threshold set by a wireless network operator. When the signal level is below the threshold, the telematics device records location and time stamp. When the telematics device detects that there is little or no coverage, the telematics device sends position and journey data, including location, time, speed information and network quality data to the telematics server via the wireless network module when there is an available wireless connection.

According to the system and method disclosed herein, a network operator may utilize the network quality data to optimize the network and an insurance company may utilize the journey data to monitor its client's automobiles usage.

### BRIEF DESCRIPTION OF THE DRAWINGS

FIG. 1 is a block diagram of a network system in accordance with one embodiment of the present invention.

FIG. 2 is a block diagram of the telematics device of FIG. 1 and related information flow in accordance with one embodiment of the present invention.

FIG. 3 is a block diagram of the telematics server of FIG. 1 and related information flow in accordance with one embodiment of the present invention.

### DETAILED DESCRIPTION OF THE INVENTION

The present invention relates to wireless networks, and more particularly to a system and method for optimizing network coverage. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiments shown, but is to be accorded the widest scope consistent with the principles and features described herein.

A system and method in accordance with the present invention for optimizing a wireless network are disclosed. The system and method enable wireless network operators to optimize network coverage by using real-time data provided by telecommunications and informatics (telematics) devices installed in automobiles. In a given automobile, the telematics device collects location, time, and speed information from a Global Positioning System module. The location, time, and speed information is used as insurance journey data. The telematics device also collects network quality data from a wireless network device. The telematics device sends the insurance journey data and network quality data to a telematics server to be forwarded to an insurance company server and a network operator server.

As a result, a network operator may utilize the network quality data to optimize the network; and an insurance company may utilize the insurance journey data to monitor its client's automobiles to flexible vehicle insurance pricing on a usage-based insurance policy. To more particularly describe the features of the present invention, refer now to the following description in conjunction with the accompanying figures.

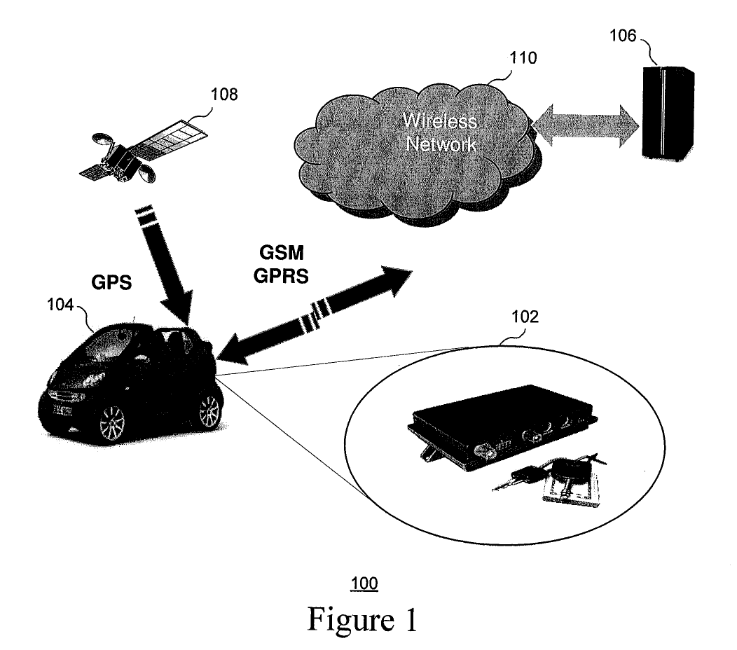

FIG. 1 is a block diagram of a network system 100 in accordance with one embodiment of the present invention. The network system 100 includes a telematics device 102 that is installed in an automobile 104, gets location/time from GPS satellites 108 and communicates with a telematics server 106 over suitable wireless networks 110. For illustrative purposes, FIG. 1 shows an example of one type of automobile. However, the present invention disclosed herein may apply to other types of vehicles including cars, trucks, vans, etc., and may apply to different makes and models of vehicles, and still remain within the spirit and scope of the present invention.

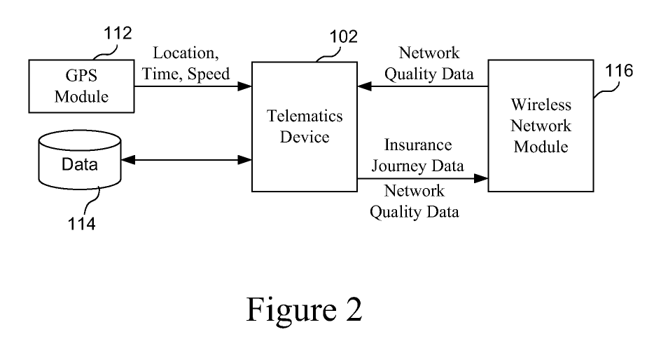

FIG. 2 is a block diagram of the telematics device 102 of FIG. 1 and related information flow in accordance with one embodiment of the present invention. As FIG. 2 shows, the telematics device 102 is operatively coupled to a GPS module 112, a database 114, and a wireless network module 116 such as a mobile phone. In one embodiment, the telematics device 102 is installed in a vehicle or is an application on a portable computer system such as a personal data assistant (PDA) or a Smart-Phone with integrated GSM and GPS modules. The wireless network module 116 is used as a sensor to read the wireless signal quality when the vehicle is in motion, and is used as a standard phone to provide an emergency voice call in case of an accident. The telematics device 102 includes a process, operating system, memory, and other suitable hardware and software applications to carry out the functionality described herein.

The telematics device 102 receives location, time, and speed information from the GPS module 112, and receives network quality data from the wireless network module 116. In one embodiment, the telematics device 102 stores and retrieves the location, time, and speed information, and the network quality data in a database 114 or other suitable storage location. In one embodiment, the location, time, and speed information are used as insurance journey data.

Once the vehicle is in operation, the telematics device 102 reads the wireless signal quality from the wireless network module 116 and compares the signal level against a threshold set by the wireless network operator. When the signal level is below the threshold, the actual location along with a time stamp from the GPS module 112 is recorded and logged in the telematics device 102. The signal level can fall below the threshold when the vehicle enters a tunnel or goes underground, for example. Recording the detailed location and time stamp enables the wireless network operator to perform an analysis of the affected area more easily and to make adjustments to the base stations. In one embodiment, the telematics device 102 checks the satellite signal from the GPS module 112 to make sure that any coverage hole areas are not already logged in order to avoid false data being sent for analysis to the network provider. When the signal is above the threshold, the logging is stopped and the latest location from GPS module 112 is also recorded.

In one embodiment, when the telematics device 102 detects that there is little or no coverage, the telematics device 102 sends insurance journey data (e.g., location, time, and speed information) and network quality data to the telematics server 106 via the wireless network module 116 when there is an available connection.

In one embodiment, the telematics device 102 is operable either manually or automatically to make an emergency call via the wireless network module 116 to the telematics server 106 if an accident occurs.

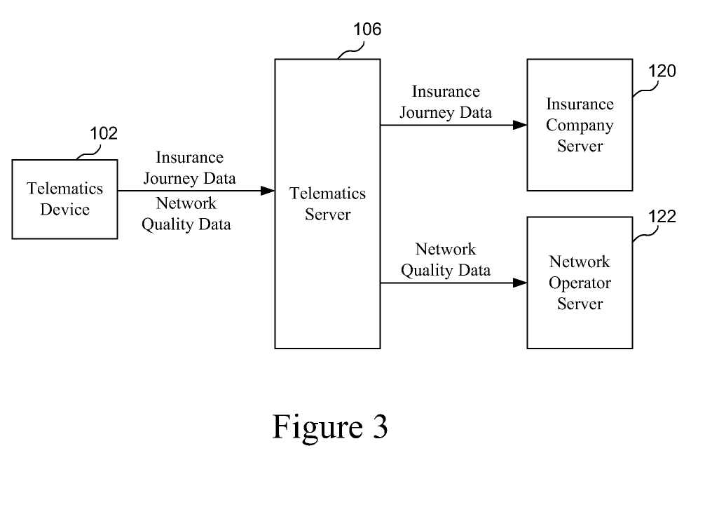

FIG. 3 is a block diagram of the telematics server 106 of FIG. 1 and related information flow in accordance with one embodiment of the present invention. As FIG. 3 shows, the telematics server 106 receives insurance journey data and network quality measurements from the telematics device 102. The telematics server 106 then sends the insurance journey data to an insurance company server 120 and sends the network quality data to a network operator server 122. The telematics server 106 includes a process, operating system, memory, and other suitable hardware and software applications to carry out the functionality described herein.

While FIG. 3 shows only one telematics device, the telematics server 106 may receives insurance journey data and network quality data from multiple telematics devices and forward all of such data to the servers of the insurance company and network operator.

According to the system and method disclosed herein, the present invention provides numerous benefits. For example, embodiments of the present invention provide automatic, real-time reporting of problems in network quality directly to the wireless network operator for optimizing the wireless network coverage for emergency calls on roads. Embodiments of the present invention also “silently” report problems (as opposed to publicly reporting problems on private websites) in a real-time manner directly to the wireless network operator for optimizing the wireless network coverage for emergency calls on roads. Embodiments of the present invention also provide a precise location (e.g., GPS position) of problematic areas where no wireless network is available for service technicians to locate the appropriate base stations. This results in time and cost savings, as it minimizes searching areas with no network coverage.

Embodiments of the present invention also enable emergency calls to be made on all roads, because the network operator will have optimized the wireless network coverage with the data provided by the telematics device 102. This reduces the number of deaths resulting from automobile accidents, because the ambulance can be notified of the emergency call via the telematics server 106. Embodiments of the present invention also enable a given insurance company to potentially receive better prices from the network operators if the telematics devices providing the important network coverage data are owned by the insurance company.

The present invention has been described in accordance with the embodiments shown. One of ordinary skill in the art will readily recognize that there could be variations to the embodiments, and that any variations would be within the spirit and scope of the present invention. For example, embodiments of the present invention may be implemented using hardware, software, a computer-readable medium containing program instructions, or a combination thereof. Software written according to the present invention or results of the present invention may be stored in some form of computer-readable medium such as memory, hard drive, CD-ROM, DVD, or other media for subsequent purposes such as being executed or processed by a processor, being displayed to a user, etc. Also, software written according to the present invention or results of the present invention may be transmitted in a signal over a network. In some embodiments, a computer-readable medium may include a computer-readable signal that may be transmitted over a network. Accordingly, many modifications may be made by one of ordinary skill in the art without departing from the spirit and scope of the appended claims.

What is claimed is:

1. A system comprising:
a telecommunications and informatics (telematics) device installed in a vehicle or an application on a portable computer system such as a personal data assistant (PDA) or a Smart-Phone;
a global positioning system (GPS) module for collecting insurance journey data that includes location, time, and speed information of a vehicle;
a wireless network module for collecting network quality data, wherein the wireless network module reads a wireless signal quality when the vehicle is in motion and is used as a standard phone to provide emergency voice calls in case of an accident; and
a memory, wherein the telematics device receives the insurance journey data from the GPS module and stores the insurance journey data in the memory, wherein the telematics device receives the network quality data from the wireless network module and stores the network quality data in the memory, wherein the telematics device compares the a signal level from the wireless network module against a threshold set by a wireless network operator, wherein when the signal level is below the threshold, the telematics device records location and time stamp from the GPS module, wherein when the telematics device detects that there is little or no coverage, the telematics device sends insurance journey data, including location, time, and speed information, and network quality data to the telematics server via the wireless network module when there is an available connection, wherein the telematics device automatically makes an emergency call via the wireless network module to a telematics server if an accident occurs.

2. The system of claim 1 wherein the telematics device stops logging the location and associated time stamp from the GPS module when the signal level is above the threshold

3. The system of claim 1 wherein the telematics device optionally either manually or automatically makes an emergency call via the wireless network module to a telematics server if an accident occurs.

4. The system of claim 1 wherein the telematics server then sends the insurance journey data to an insurance company server and sends the network quality data to a network operator server.

5. A system comprising:
a telecommunications and informatics (telematics) server;
a telematics device installed in a vehicle or an application on a portable computer system such as a personal data assistant (PDA) or a Smart-Phone;
a global positioning system (GPS) module for collecting insurance journey data that includes location, time, and speed information of a vehicle;
a wireless network module for collecting network quality data, wherein the wireless network module reads a wireless signal quality when the vehicle is in motion and is used as a standard phone to provide emergency voice calls in case of an accident; and
a memory, wherein the telematics device receives the insurance journey data from the GPS module and stores the insurance journey data in the memory, wherein the telematics device receives the network quality data from the wireless network module and stores the network quality data in the memory, wherein the telematics device compares the a signal level from the wireless network module against a threshold set by a wireless network operator, wherein when the signal level is below the threshold, the telematics device records location and time stamp from the GPS module, wherein when the telematics device detects that there is little or no coverage, the telematics device sends insurance journey data, including location, time, and speed information, and network quality data to the telematics server via the wireless network module when there is an available connection, wherein the telematics device optionally manually or automatically makes an emergency call via the wireless network module to a telematics server if an accident occurs, wherein the telematics server receives insurance journey data and network quality measurements from the telematics device, wherein the telematics server sends the insurance journey data to an insurance company server and sends the network quality data to a network operator server.

6. The system of claim 5 wherein the telematics device stops logging the location and associated time stamps from the GPS module when the signal level is above the threshold
